(19) United States
(12) Patent Application Publication
(10) Pub. No.: US 2004/0029766 A1
(43) Pub. Date: Feb. 12, 2004

(54) Solid amphoteric surfactants

(76) Inventors: Hendrick Petrus Frick, Scotland (GB); Stuart William Jackson, Worcestershire (GB); Ajit Kumar, West Midlands (GB); Viral Bobby Patel, West Midlands (GB)

Correspondence Address: Legal Department, Huntsman, PO Box 15730, Austin, TX, 78761, US

(21) Appl. No.: 10/380,574

(22) PCT Filed: Sep. 10, 2001
(86) PCT No.: PCT/EP01/10403

(30) Foreign Application Priority Data
Sep. 16, 2000 (GB) 0022765.2
Aug. 8, 2001 (GB) 0119292.1

(51) Int. Cl. C11D 1/00

(52) U.S. Cl. 510/499

(57) ABSTRACT

Desalted amphoteric surfactant which is a carboxyalkylated, sulphonoalkylated or phosphonoalkylated amine, said amine consisting essentially of a single homologue having an aliphatic substituent with more than 13 carbon atoms is dried at low temperature to a non-hygroscopic said.

The present invention relates to solid surfactants and in particular to solid amphoteric surfactants and to methods for their preparation.

The expression “amphoteric surfactant” is used herein in the usual sense in which it is employed in the surfactant industry i.e. including zwitterionic surfactants such as quaternary betaines, even though the latter are not strictly speaking amphoteric.

Aqueous amphoteric surfactants are usually only pourable at relatively low concentrations, e.g. up to about 30% to 45% by wt. depending on the alkyl chain distribution. The formation of immobile or very highly viscous mesophases prevents them being produced and used at higher concentrations, except by using organic solvents, which are undesirable on grounds of cost, fire hazard, environmental impact and possible adverse effects on any formulation in which the surfactant may be incorporated. It is nevertheless desirable that surfactants be supplied at as high a concentration as possible in order to reduce storage and transport costs, to obviate the need for preservatives and to give formulators greater flexibility to make formulations containing low levels of water.

For most purposes surfactants are preferably supplied as spray or drum dried solids which are substantially anhydrous. For heat-sensitive surfactants, freeze drying may be used. Amphoteric surfactants are not usually heat sensitive and can be dried conventionally, but nevertheless cannot be supplied as solids, in practice, because they are too hygroscopic. They are generally deliquescent, the powder absorbing sufficient moisture to form a highly viscous intractable M-phase giving rise to serious handling problems and precluding their use in dry formulations.

The most important category of amphoteric surfactants commercially are the betaines on account of their mildness, cleaning power and foaming characteristics. They are widely used in personal care and detergent formulations. They are usually made by reacting amines with sodium chloroacetate. The reaction results in a product containing at least a stoichiometric amount of sodium chloride, which is an unavoidable by-product of the reaction, and is usually about 20% based on the weight of active matter. It is also possible to carry out the reaction using potassium or ammonium in place of sodium, but the additional cost is a substantial commercial disadvantage. The product is normally supplied as a solution containing about 35% surfactant and 7% of salt based on the weight of the solution.

Sulpho-betaines are analogous to betaines, being formed by reacting the same amines with epichlorohydrin and sodium bisulphite, instead of sodium chloroacetate. The sulphono methylated products behave similarly to betaines, and the description herein relating to betaines generally applies to sulphobetaines and also to phosphobetaines.

For some applications the presence of salt is a disadvantage. Salt may be removed from amphoteric surfactants, either during or after preparation, for example by electrodiaylsis (e.g. as described in our GB 1 525 692 or in EP 0 736 521 patents), by membrane filtration (for example as described is EP 0 626 881) or, less preferably, by displacing metal ion e.g. using ion exchange or by solvent precipitation. Alternatively, it is possible to prepare amphoterics with low salt levels by quaternising with acrylic acid.

The term salt as used herein includes all alkali metal chlorides and ammonium chloride. Typically the salt is sodium chloride, or more rarely potassium or ammonium chloride formed as a by-product of the quaternisation of the amine with chloroacetate.

Particularly important commercially is coconut amido propyl betaine, commonly referred to as “CAPB”. CAPB has the formula RCONH(CH₂)₃N⁺(CH₃)₂CH₂COO⁻ where R represents a mixture of alkyl chain lengths corresponding on average to those present in unrefined coconut or palm oil fatty acids. Typically coconut fatty acids contain a mixture of fatty acids having 8, 10, 12, 14, 16 and 18 carbon atoms in which lauric acid (C₁₂) is the main component. The term CAPB is often used broadly to include amido propyl betaines obtained from other fatty acid feedstocks having the same or similar distribution to coconut fatty acid.

Coconut fatty acids are usually hardened by hydrogenating at least part of the unsaturated components, and in addition may be “cut” by removing the C₈₋₁₀ fatty acids. They may be further refined to remove the C₁₄₋₁₈ fatty acids to leave substantially pure (i.e. greater than 90%) lauric acid. Lauric acid amido propyl betaine is referred to herein as LAPB.

We have previously shown (see GB1525 692) that betaines can be obtained, at higher concentrations than normal as clear, mobile, optically isotropic micellar solutions at ambient temperatures by reducing the salt content. However at such raised concentrations, betaines have an undesirably high set point. The phenomenon is most marked with uncut CAPB which can be obtained at concentrations of up to about 45% when desalted. However, even desalted uncut CAPB cannot be dried to a stable non-hygroscopic solid. LAPB cannot be concentrated to the same levels as uncut CAPB.

We have now discovered that, desalted amphoteric surfactants which are the carboxyalkylated, sulphonoalkylated or phosphonoalkylated derivatives of an amine which consists, essentially of a single homologue and which has an aliphatic substituent with a total of more than 13 carbon atoms, such as desalted LAPB, can be dried to a water content of from 1 to 12.5% by weight. This composition can be obtained as a stable, non-hygroscopic, free-flowing powder, provided that the drying is affected at a temperature below the softening point of the product. This is appreciably lower than the normal temperature at which amphoterics have conventionally been dried.

The minimum proportion of the predominant homologue required may depend on the molecular weight of the surfactant. In the case of LAPB it is necessary to have more than 90% lauryl amidopropyl betaine in order to obtain a non-hygroscopic product.

Our invention provides a non-deliquescent solid amphoteric surfactant product which is a carboxyalkyl, sulphonoalkyl or phosphonoalkyl derivative of an amine consisting essentially of a single homologue and having an aliphatic substituent with more than 13 carbon atoms, and the said solid containing less than 10% by weight of salt and from 1 to 12.5% by weight of water.

The product consists essentially of said surfactant, water and any residual salt. The surfactant constitutes more than 80%, preferably more than 85% e.g. more than 90% by weight of the product.

Typically the amine from which the surfactant is derived has one aliphatic substituent with more than 13 carbon atoms which is a long chain, hydrophobic substituent wherein the chain is formed of carbon and hydrogen atoms, optionally with one or more nitrogen and/or oxygen atoms and/or, less commonly, one or more sulphur and/or phosphorus atoms. The expression “long chain” means having more than 10 atoms and preferably more than 12 atoms, in a linear arrangement (excluding hydrogen atoms or any atoms in side chains). The amine may also have up to two short chain aliphatic substituents each having less than five carbon atoms in total. The short chains are typically methyl, ethyl, hydroxyethyl, propyl or butyl groups, the long chains are typically lauryl amido propyl, tetradecyl amido propyl, tetradecyl, palmityl amido propyl, palmityl, stearyl amido propyl, stearyl or less preferably oleyl amido propyl, oleyl or erucyl amido propyl or erucyl. The chain may optionally include one or more ether, ester or keto groups, e.g. polyoxypropylene.

According to a second embodiment, our invention provides a method for making a solid betaine from a solution obtained by reacting a tertiary amine or amido amine having an aliphatic substituent containing more than thirteen carbon atoms and consisting at least predominantly of a single homologue, with an alkali metal chloroacetate in aqueous solution, and reducing the salt content of the solution to less than 10% by weight based on the weight of betaine, which method comprises lowering the water content of said solution below 12.5% at a temperature below the softening point of the product.

Alternatively the above process may be carried out using epichlorohydrin and sodium bisulphite in the first step instead of sodium chloroacetate to form a sulphobetaine.

The products of our invention are substantially non-hygroscopic. By this is meant that they form a solid having an equilibrium water content below 12% at 40° C. in an atmosphere having 65% humidity.

The products of our invention typically have the formula:

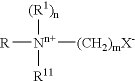

Wherein: R is the aliphatic group containing more than 13 carbon atoms; R¹ and R¹¹ are each, independently, hydrogen or an ethyl, hydroxyethyl or most preferably a methyl group; m is 1 or 2; X is a phosphono, sulphono, or, preferably, carboxy group; and n is 0 or, preferably, 1.

R preferably has from 14 to 25 carbon atoms and is desirably a straight chain alkyl or alkyl amido alkylene group, especially a group of the formula CH₃(CH₂)ₐCONH(CH₂)_{b} where (a+b) is from 12 to 23 and b is preferably 2 or most preferably 3.

It appears that amphoteric surfactants wherein the longest chain aliphatic substituent contains less than 14 carbon atoms do not form non-hygroscopic products when free from other homologues, even when desalted. The alkyl dimethyl betaines and alkyl amido propyl dimethyl betaines, having a total of more than 17 carbon atoms and wherein the alkyl feedstock is derived from natural fatty acids which are straight chain, saturated and have an even number of carbon atoms, all form non-hygroscopic solid products when free from other homologues if the salt and moisture levels are within the specified parameters.

Products derived from unsaturated feedstocks, or from synthetic feedstocks, which are usually branched chain, and/or which may comprise an odd number of carbon atoms, or products with hydroxyl groups, such as alkyl (bis 2-hydroxyethyl) betaines may require an aliphatic substituent with a higher minimum number of carbon atoms e.g. more than 14 or in some cases more than 15 or even 16 carbon atoms to form a fully free flowing powder product depending on the extent of branching, number of double bonds and/or number of hydroxyl groups.

Preferably the salt content of the dried product is less than 9% by weight, more preferably less than 8%, typically less than 7%, more typically less than 6%, most typically less than 4.5% especially less than 3%, more especially less than 2%, most especially less than 1, e.g. less than 0.5%. The compositions are particularly sensitive to sodium chloride. However we generally prefer that the total level of inorganic salt is less than 10%, more preferably less than 9% especially less than 5% most preferably less than 3%.

Salt may be removed from the aqueous feed by any convenient method such as membrane filtration or electrodialysis. Typically a 25 to 34% aqueous solution is desalted to a salt concentration relative to the surfactant concentration in the aqueous feed equivalent to the desired final ratio of salt to surfactant in the solid product.

For the purpose of this specification products shall be deemed to consist essentially of a single homologue if that homologue is present in a concentration of more than 80% by weight of the total surfactant and sufficient, in the absence of salt, to form a non-deliquescent solid.

Preferably the amine has more than 88% more preferably more than 90%, most preferably more than 94%, typically more than 95%, more typically more than 96%, most typically more than 97%, by weight consisting of a single homologue. The minimum proportion of the single homologue may be lower for higher molecular weight products. For commercial reasons it is not usually practicable to achieve purity greater than 99.5% and in practice the purity is usually less than 99% e.g. less than 98.5%. Most typically the amine is from 96 to 98% pure.

The amine is preferably a tertiary amine and most preferably laurylamidopropyl dimethylamine. Alternatively, the amine may, for example, be tetradecyl dimethylamine, palmityl dimethylamine, stearoyl dimethylamine, tetradecylamidopropyl dimethylamine, palmitylamidopropyl dimethylamine, stearoylamidopropyl dimethylamine, oleyl dimethylamine or oleylamidopropyl dimethylamine.

Difficulty may be experienced drying the so-called quaternary imidazoline betaines, also called ampho acetates, and traditionally ascribed the formula:

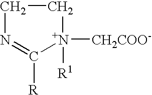

because they are obtained by reacting sodium chloroacetate with an imidazoline. It has been shown, however, that. they are actually present, at least predominantly, as the corresponding linear amido amine

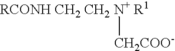

Which is usually obtained commercially in admixture with the dicarboxymethylated form

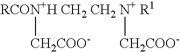

For this reason commercial lauryl amphoacetate cannot be dried even after desalting unless the preparative conditions are adapted to favour predominantly the mono carboxy form.

The water content of the amphoteric surfactant is preferably reduced to a value of from 2.5 to 12% more preferably 3 to 10% especially 4 to 8% e.g. 5 to 7%. Drying may, for example, be effected by the application of reduced pressure, e.g. by vacuum or freeze drying.

If it is desired to prepare solid mixtures comprising a plurality of homologues, it is possible to prepare each homologue separately and finally mix the dried powders. The invention includes mixtures of dried homologues so prepared.

Drying is preferably effected below the softening temperature of the product, which is typically around 50 or 70° C., e.g. below 60° C., preferably below 50° C. We particularly prefer freeze dried products. Unlike conventional amphoterics, the products of our invention form stable, crystalline, stoichiometric hydrates which soften at elevated temperatures due to loss of water of crystalisation. They are sticky and difficult to recover if dried above this temperature.

The non hygroscopic/non deliquescing nature of amphoteric products of the invention and of the lauryl amido propyl betaine product in particular make it possible to formulate these products into stable powder, granular, solid extruded or pressed products where one or more of the following characteristics are required:

Foam boosting

Foam stabilising (especially in hard water systems)

Mildness

Detoxification of other surfactants

Detergency

Wetting

Air entrainment

Applications have been found for these products, in detergent tablets (with non-ionic surfactants or as the sole surfactant to provide strong detergency and tablet binding), foaming bath salts, e.g. in formulations based on sodium lauryl sulphate and sodium sesquicarbonate, and/or talc, foaming bath bombs (e.g. in formulations based on sodium lauryl sulphate, sodium bicarbonate and citric acid), Syndet bars (e.g. when formulated with sodium coconut isethionate to increase lather and mildness), combars (e.g. with soap to increase lather and detoxification of soap), WC blocks, hard surface cleaner concentrates, metal and transport cleaning concentrates (e.g. with non-ionics in acid, alkaline or solvent based formulations), as dry air entrainment agents for concrete, mortar and plasterboard and in non-aqueous systems or oil emulsion based systems (such as single phase oil based bath and shower oil formulations).

The invention is illustrated by the following examples:

### EXAMPLE I

Samples of desalted and undesalted aqueous alkyl amido propyl betaine (AAPB) solutions, shown in Table 1, were vacuum dried. The desalted feeds had a sodium chloride content of less than 0.5% by weight, while the undesalted aqueous feeds all contained more than 6% by weight sodium chloride. The caprylic, capric, lauric, myristic and palmitic feedstock's had a purity of more than 96% of the single homologue. The freeze dried products were ground to powders and placed in a humidity cabinet at 40° C. and at 65% humidity for 30 hours. All undesalted AAPB's and the desalted AAPB's based on caprylic and capric feedstock's as well as desalted samples based on uncut and bottom cut coco fatty acids rapidly caked, and deliquesced to form a sticky intractable gel. Desalted samples based on the lauric, myristic and palmitic feedstock's remained free flowing non-hygroscopic powders containing 6-7.5% moisture even after three weeks storage at 40° C. and 65% humidity. Equilibrium moisture contents after prolonged storage in the moisture cabinet is shown in Table 1.

TABLE 1
Humidity Testing (AAPB's)

| | % Moisture | |
|---|---|---|
| Feed | (weight) | State |
| Undesalted bottom cut CAPB | 17.8% | Sticky gel |
| Desalted uncut CAPB | 15.6% | Sticky gel |
| Desalted bottom cut CAPB | 13.6% | Sticky gel |
| Undesalted LAPB | 19.3% | Sticky gel |
| Desalted LAPB | 6.1% | Free flowing powder |
| Desalted C8 AAPB | 19.5% | Sticky gel |
| Desalted C10 AAPB | 16.7% | Sticky gel |
| Desalted C14 AAPB | 7.1% | Free flowing powder |
| Desalted C16 AAPB | 7.5% | Free flowing powder |

### EXAMPLE II

Aqueous laurylamidopropyl betaine (LAPB) solutions were prepared with various NaCl concentrations and freeze dried. Samples were ground to a powder and exposed to high humidity as in Example I. Table 2 shows the effect of NaCl concentration on equilibrium moisture content and product properties.

TABLE 2
AAPB: Humidity Testing (Effect of NaCl concentration)

| % NaCl | % Moisture | |
|---|---|---|
| (weight)* | (weight) | State |
| 0.3% | 6.1% | Free flowing non-sticky powder |
| 1.0% | 7.4% | Free flowing non-sticky powder, with |
| | | some lumping that can be crushed to |
| | | powder |
| 1.9% | 8.7% | Compressible, slightly sticky powder, with |
| | | a lot of lumps |
| 3.0% | 11.8% | Sticky, compressible powder, severely |
| | | lumped, cannot be crushed to powder |
| 6.0% | 17.6% | Sticky gel |
| 11.1% | 19.3% | Sticky gel |

Notes

* % NaCl in dried product prior to humidity testing

### EXAMPLE III

Feedstock with 98% lauric acid were incrementally mixed with various amounts of single homologue straight chain fatty acids to prepare amido propyl betaines which were desalted and freeze dried. Samples were ground to powder and exposed to high humidity as in Example I. Table 3 shows the effect of alkyl chain homogeneity on equilibrium moisture content and product properties.

TABLE 3
AAPB: Humidity Testing (Effect of alkyl distribution)

| | % | |
|---|---|---|
| | Moisture | |
| Alkyl Distribution | (weight) | State |
| 98.2% C12 | 6.1 | Free flowing non-sticky |
| | | powder |
| 94% C12 + 6% C8 | 7.2% | Free flowing compressible |
| | | powder |
| 94% C12 + 6% C10 | 8.3% | Compressible powder, |
| | | slightly sticky |
| | | powder with a lot of lumps |
| 88% C12 + 6% C8 + 6% C10 | 10.2% | Sticky, compressible |
| | | powder, with lumps |
| | | that cannot readily be |
| | | crushed into a powder |
| 94% C12 + 6% C14 | 11.8 | Free flowing compressible |
| | | powder with lumps that |
| | | can be crushed |
| 94% C12 + 6% C16 | 13.3 | Sticky, compressible |
| | | powder severely lumped, |
| | | cannot readily be |
| | | crushed to powder |
| 88% C12 + 6% C14 + 6% C16 | 13.5 | Sticky gel |

### EXAMPLE IV

Sample of desalted and undesalted aqueous alkyl dimethyl amine betaines (hereon after referred to as BB) solutions, shown in Table 4, were vacuum dried. The desalted feed solutions had a sodium chloride content of less than 1.0% by weight, while the undesalted aqueous feeds all contained more than 6% by weight sodium chloride.

The lauric, myristic an palmitic feedstock's had a purity of more than 95% of single homologue. The freeze dried products were ground to powders and placed in a humidity cabinet at 40° C. and 65% humidity for 30 hours. All undesalted BB's and the desalted BB based on the lauric feedstock deliquesced to form a sticky intractable gel. Desalted sampled based on the myristic and palmitic feedstock's remained free flowing non-hygroscopic powders containing 8-8.5% moisture even after three weeks storage at 40° C. and 65% humidity. Equilibrium moisture contents after prolonged storage in the moisture cabinet is shown in Table 4.

TABLE 4
Humidity Testing (BB's)

| Feed | % Moisture (weight) | State |
|---|---|---|
| Undesalted C12 BB | 20.0 | Sticky gel |
| Desalted C12 BB | 18.2 | Sticky gel |
| Undesalted C14 BB | 17.9 | Sticky gel |
| Desalted C14 BB | 8.4 | Free flowing powder |
| Undesalted C16 BB | 18.5 | Sticky gel |
| Desalted C16 BB | 8.3 | Free flowing powder |

1. A solid amphoteric surfactant product consisting essentially of: water; any residual salt; and a surfactant which is a carboxyalkylated, sulphonoalkylated or phosphonoalkylated derivative of an amine said amine comprising a hydrophobic long chain aliphatic substituent characterised in that:
(A) said surfactant constitutes more than 80% of the total weight of the product;
(B) the long chain aliphatic substituent consists essentially of a single homologue having more than 13 carbon atoms;
(C) the salt (e.g. alkalimetal chloride and ammonium chloride content is less than 10% based on the total weight of the product; and
(D) the water content is between 1 and 12.5% based on the total weight of the product.

2. A product according to claim 1 wherein said long chain aliphatic constituent has from 14 to 25 carbon atoms.

3. A product according to either of claims 1 and 2 wherein the salt content is less than 6% based on the total weight of the product

4. A product according to claim 3 wherein the concentration of salt is less than 5% based on the total weight of product.

5. A product according to claim 4 wherein the concentration of salt is less than 3% based on the total weight of product.

6. A product according to claim 5 wherein the concentration or salt is less than 2% based on the total weight of product.

7. A product according to any foregoing claim wherein the water content is from 2 to 12% by weight based on the total weight of product.

8. A product according to any foregoing claim wherein the water content is from 4 to 8% based on the total weight of the product.

9. A product according to any foregoing claim wherein said long chain aliphatic substituent consists of more than 90% by weight of a single homologue.

10. A product according to claim 9 wherein said long chain aliphatic substituent comprises from 94 to 99% by weight of a single homologue.

11. A product according to any foregoing claim wherein said long chain aliphatic substituent is a straight chain alkyl or alkyl amido alkylene group.

12. A product according to any foregoing claim wherein said surfactant has the formula 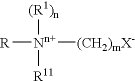
Wherein R is a long chain aliphatic group having more than 13 carbon atoms;
R¹ and R¹¹ are each hydrogen or a methyl, ethyl or hydroxyethyl group'; X is a carboxy, sulphono or phosphono group, n is 0 or 1 and m is 1 or 2.

13. A product according to claim 12 wherein X is a carboxy group.

14. A product according to either of claims 12 and 13 wherein n is 1.

15. A product according to any of claim 12 to 14 wherein m is 1.

16. A product according to any of claims 12 to 5 wherein R¹ and R¹¹ are each methyl groups.

17. A product according any of claim 12 to 16 wherein R is an alkyl or alkylamidopropyl group.

18. A product according to any foregoing claim wherein said surfactant constitutes more than 90% of said composition.

19. A product according to claim 12 comprising more than 90% by weight thereof of lauryl amido propyl betaine.

20. A product according to any foregoing claim wherein the total inorganic salt is less than 10% by weight.

21. A product according to claim 20 wherein the total inorganic salt is less than 5% by weight.

22. A mixture of two or more different surfactant products according to any foregoing claim

23. A method of making a product according any of claims 1 to 21 which comprises drying an aqueous solution of said surfactant at a temperature below the softening point of said product.

24. A method according to claim 23 which comprises freeze drying.

25. A method according to either of claims 23 and 24 which comprises the steps of: reacting an amine capable of forming, on chloromethylation, a betaine according to any of claims 1 to 21, with alkali metal chloroacetate to form an aqueous solution of said surfactant and alkali metal chloride; reducing the salt content of said solution to less than 10% by weight of the surfactant; and drying said solution to a moisture content of less than 10% by weight.

26. A method according to claim 25 wherein said alkali metal is sodium

27. A method as specified in claim 26 except that epichlorohydrin and sodium bisulphite are used instead of sodium chloroacetate in the first step.
